(19) United States
(12) Patent Application Publication
(10) Pub. No.: US 2021/0112777 A1
(43) Pub. Date: Apr. 22, 2021

(54) Rope Pet Toy

(71) Applicants: Nicholas Richard Watts, Westlake Village, CA (US); Elizabeth Bentz, Denver, CO (US); Danielle Salyer, Denver, CO (US)

(72) Inventors: Nicholas Richard Watts, Westlake Village, CA (US); Elizabeth Bentz, Denver, CO (US); Danielle Salyer, Denver, CO (US)

(21) Appl. No.: 16/659,566

(22) Filed: Oct. 21, 2019

(51) Int. Cl. A01K 15/02; G10K 5/00

(52) U.S. Cl. CPC A01K 15/025; G10K 5/00

(57) ABSTRACT

The invention is a plush and fabric animal shaped toy with sections of rope that extend out from the body of the toy and are connected via surgical tubing inside the plush toy that pull apart two layers of hook and loop material causing a ripping sound similar to that of Velcro®. When the rope is released the hook and loop halves are reconnected and ready for the animal to pull again. The plush animal has embroidered face detail and squeakers and cellophane material located in the head or limbs of the toy adding additional noises to emit from the toy when a pet is playing with it.

### FIELD

The present invention relates generally to stimulating, encouraging and motivating games and methods of playing regarding pets, e.g. dogs and cats. More particularly, the invention relates to motivational games, toys and methods for assessing the pet training skills in the form of games or puzzles that incite pet interaction and memory skills.

### PRIOR ART

There are many types of pet toys on the market that squeak or that can be used in a tug-of-war game between an owner and a dog, or multiple dogs without their owner's interaction. This novel toy is designed to make a “ripping” sound when two roped loops at either end of a plush toy are tugged on by a pet owner and a pet, or by two pets playing together.

### BRIEF DESCRIPTION OF THE INVENTION

The novel design of the inventive toy satisfies a dog's instinct to tug and tear at a toy that makes noise in response. Studies have shown that even the most domesticated dog retains an ancestral instinct to actually kill its prey. Enter toys designed to make sounds in response to the dog's “attack”.

The object of the present invention is to motivate and maintain interest of a pet, and also be a durable toy that continues to function after being aggressively used by a pet. Pet owners spend several billion dollars per year on pet toys, and this toy provides great value for the price.

Veterinarians caution pet owners about using the right kind of toy especially when the pet will be left alone for time periods. The toy should be durable, and not contain small pieces easily swallowed, but not so easily expelled. The inventive toy meets that criteria as well as providing the audible stimuli that will keep a dog interested in the toy, and hopefully not so interested in the couch.

### BACKGROUND OF THE INVENTION

The invention most closely corresponds with USPTO Class 119/707 wherein Class 119 relates to animal husbandry and sub-class 707 includes toys.

In its simplest form, the invention relates to a novel toy for pets wherein a plush toy with rope inside the plush body forms loops extending from either end of the plush body. The rope sections are connected inside the plush body to a length of surgical tubing that is then attached to a strip of Velcro which makes a ripping sound as the loops are pulled from either end of the toy.

### THE INVENTION

### Summary, Objects And Advantages

It well known that pets do experience a sense of boredom, and if not addressed, may manifest in negative behavior such as chewing furniture or going to the bathroom in undesirable locations in the pet owner's home. When presented with a toy that makes a high-pitched squeaky noise, many dogs will revert to a stylized version of the shake and kill pattern of their wild ancestors. This prey-cry trigger can cause dogs to rip apart their toys in an effort to get to the sound and “kill” the squeak. Our positive attention encourages our dogs to continue pulling apart toys until it's a hard habit to break.

### BRIEF DESCRIPTION OF THE DRAWINGS

The invention is described in further detail by reference to eight (8) drawings sufficient in detail to describe the invention in which:

FIG. 1 is an exterior view of the plush and rope animal toy;

FIG. 2 is an illustration of the internal rope and tubing features of the toy;

FIG. 3 is a magnified view of the squeaker located inside the head portion of the toy;

FIG. 4 is an example of another toy character, here an elf, to illustrate the basic toy can be configured simply into other characters or shapes;

FIG. 5 is another perspective of the elf plush toy internal rope and tubing features;

FIG. 6 is a magnified view of plush features, in this example a character's ear;

FIG. 7 is an exterior perspective of the plush and rope elf character; and

FIG. 8 is a magnified perspective of the surgical tubing and Velcro strip.

### DETAILED DESCRIPTION, INCLUDING BEST MODES OF CARRYING OUT THE INVENTION

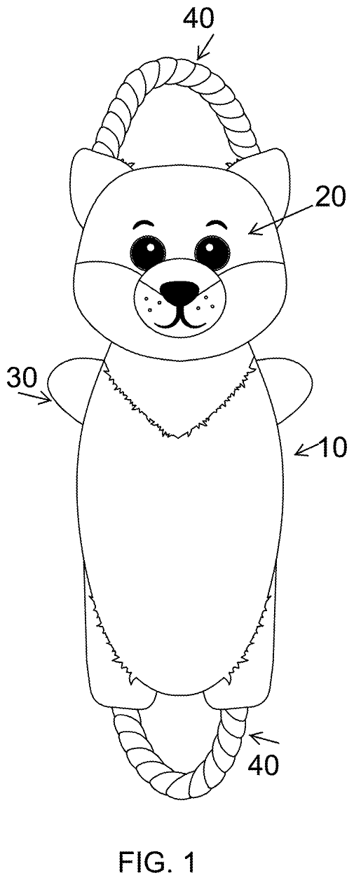

FIG. 1 shows the plush and rope fox character with the plush body 10, and head with facial features 20 which may be embroidered or printed on the plush. Two rope loops 40 extend out of either end of the toy to create a durable section for a pet to bite and tug on. A limb or leg section 30 is turn seam constructed inside the body of the character and will contain sections of plastic that will create a “crinkling” sound when the pet chews or tugs on the limbs.

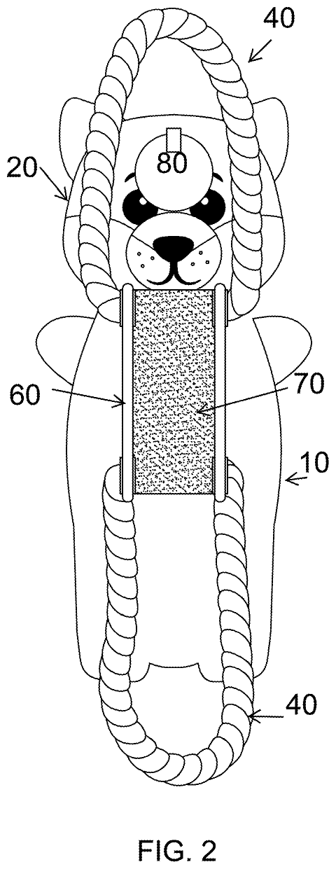

FIG. 2 illustrates the internal workings of the toy. Again, the plush body 10 and head 20 are shown on the fox embodiment. This Figure shows the rope loops 40 as they then attach to a section of Velcro 60 controlled by surgical tubing 70. The section of Velcro is mated so as to pull apart from one another when the rope loops are pulled causing the surgical tubing to expand and roll back one layer of the Velcro stripping. This action then produces a “ripping” sound well know to users of Velcro. When the rope sections are released, the surgical tubing will contract and allow the section of Velcro to unroll and return to a mated state and is ready to respond to a next tugging process. Within the head of the fox a reed squeaker is placed to add additional noisemaking capabilities when the pet bites down on the head portion.

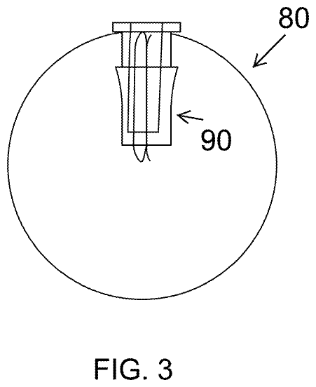

FIG. 3 is a magnified view of the circular internal squeaker 80 with a tuned reed for creating a high-pitched sound when the head of the character is bitten or compressed by the pet.

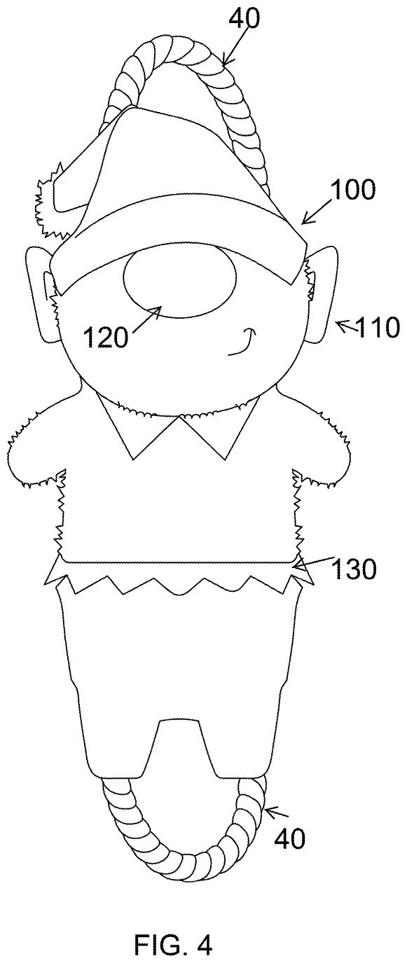

FIG. 4 is an example of another character, here an elf, that is also plush with embroidered facial features but adds trim such as a plush and felt hat 100 which is 2-piece turned, folded and set to head. Plastic crinkle material may be placed inside the hat to create sounds. Ears 110 are 2-piece turned construction with crinkle inside and set into the side of the head of the toy. A 3-d nose 120 is constructed of felt or fabric and protrudes from the face of the toy and has polyfill stuffing. The head of this embodiment is also 2-pieced turned construction with topset and embroidery details with a noisemaker and polyfill set inside. Additional felt features include a skirt 130 or collar features. The rope loops 40 are again shown extending out of both ends of the toy.

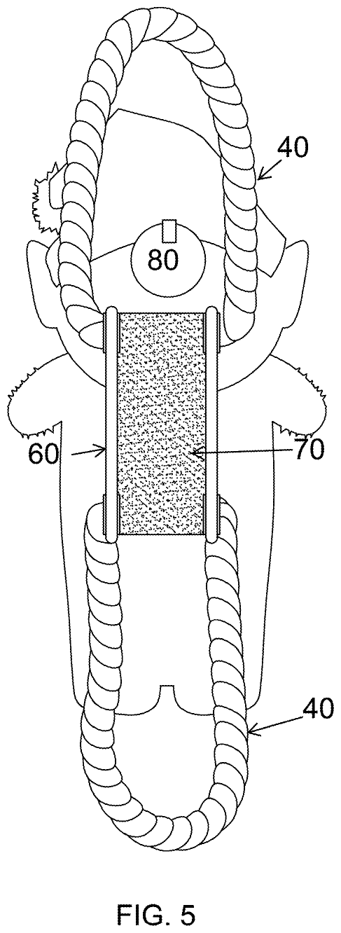

FIG. 5 illustrates the internal workings of the elf toy. Again, the plush body 10 and head 20 are shown on the fox embodiment. This Figure shows the rope loops 40 as they then attach to a section of Velcro 60 controlled by surgical tubing 70. The section of Velcro is mated so as to pull apart from one another when the rope loops are pulled causing the surgical tubing to expand and roll back one layer of the Velcro stripping. This action then produces a “ripping” sound well known to users of Velcro. When the rope sections are released, the surgical tubing will contract and allow the section of Velcro to unroll and return to a mated state and is ready to respond to a next tugging process. Within the head of the fox a reed squeaker is placed to add additional noisemaking capabilities when the pet bites down on the head portion.

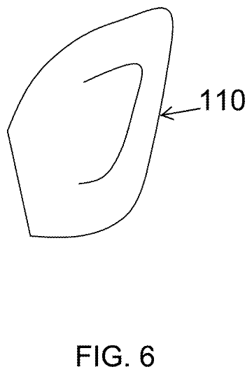

FIG. 6 is a magnified view of a felt ear 110 that is turn seamed sewed onto the head of the elf character.

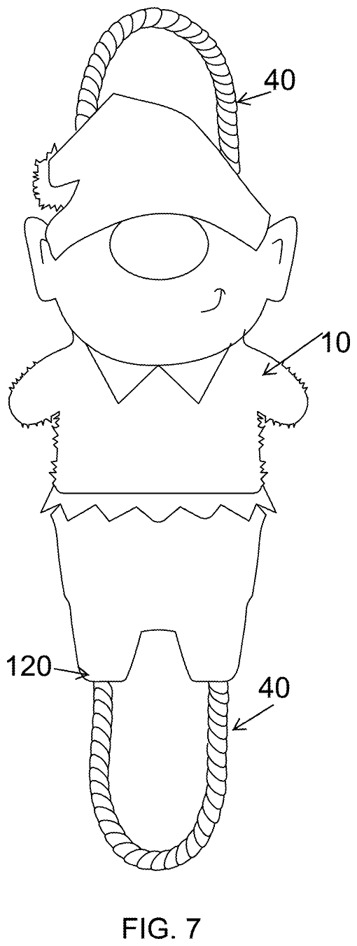

FIG. 7 is a view of the elf figure body 10 with each loop of rope 40 as extends out the head and legs of the elf character. The section of rope at the head of the elf is sewn into the plush head with a turned seam construction wherein the head and rope section remain connected together during movement when the loop of rope is pulled. The rope at the feet of the character 40 is allowed to slide through and from the legs wherein the rope is not sewn to the plush. This section of rope when pulled causes the surgical tubing of the head piece to separate the Velcro strip within the toy to make a ripping sound.

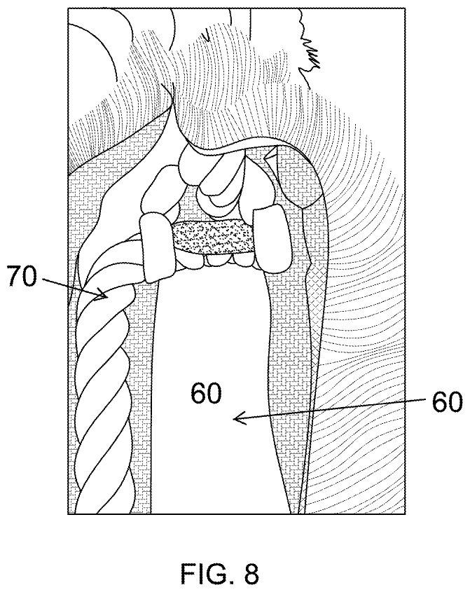

FIG. 8 shows a magnified view of the surgical tubing 70 and the section of Velcro 60 as beginning the process or wrapping around the Velcro strip and as it does, the Velcro halves are separated creating a ripping sound. When the rope is tugged at the head section, the Velcro material wraps or rolls around the surgical tubing and as it rolls the sections of Velcro will become detached and create a ripping sound. When the ropes are released, the elasticity of the surgical tubing relaxes, and the Velcro strips return to their home or unrolled state wherein the Velcro strips are again fully layered or stuck together.

1) A pet toy comprising:
a) A plush rope animal shaped toy with a head, body, 3-D and embroidered facial features, and limbs;
b) At least one looped rope section which creates a handle for pulling the head of the toy;
c) A second looped rope section which is looped within the interior of the plush toy body and extends out of limbs of the body;
d) A length of surgical tubing which is affixed to the rope in the head of the toy and to a second section of looped rope on the interior of the plush body of the toy which second section of rope is also connected to one half of a hook and loop fabric and which responds to force on the ropes to move a section of hook and loop material located within the body of the toy;
e) A second section of hook and loop fabric which is sewn onto the plush fabric interior of the toy in a fixed manner that remains fixed when the first half of the material is separated from it in response to tension placed on the surgical tubing in response to the first section of rope being pulled;
f) At least one of a reed squeaker located in the head of the plush toy; and
g) Cellophane material located in at least one of the limbs of the toy.

2) A pet toy as in claim 1 wherein a plush fabric forms a head, body and limb features of an animal shaped toy wherein facial features are embroidered on the face or limbs of the toy and in some embodiments a 3-D feature such as a nose can be located on the head of the toy.

3) A pet toy as in claim 1 wherein at least one looped rope section is affixed to and through the head of the toy wherein the section of rope located within the plush body may be attached to at least one section of surgical tubing so that the head and rope move simultaneously when the rope is pulled.

4) A pet toy as in claim 1 wherein at least a second looped rope section is located within the body of the toy and extends out the limbs of the toy wherein the limbs contain apertures that are not sewn to the rope so that it will move freely therethrough when the rope is pulled.

6) A pet toy as in claim 1 wherein at least one length of surgical tubing is located within the body of the toy and attached to a first and second section of rope and wherein pulling at least one section of rope causes one layer of hook and loop material to pull away from the second section of material and wrap around the tubing causing it to separate from the second section of hook and loop material and create a ripping sound as the halves separate.

8) A pet toy as in claim 1 wherein releasing at least one portion of looped rope causes the surgical tubing to expand and causes one later of the hook and loop section to roll out and back to a position where it and the fixed half of material are reconnected to one another.

7) A pet toy as in claim 1 wherein at least one reed squeaker is located within the head of the toy and will make a squeaking sound when depressed.

8) A pet toy as in claim 1 wherein a thin layer of cellophane material is located within at least one of the limbs of the oy and will make a crinkling sound when manipulated by a pet.
